(19) United States
(12) Patent Application Publication
(10) Pub. No.: US 2015/0344321 A1
(43) Pub. Date: Dec. 3, 2015

(54) WATER FILTER ASSEMBLY

(71) Applicant: General Electric Company, Schenectady, NY (US)

(72) Inventor: Michael Lee Alsip, Louisville, KY (US)

(73) Assignee: General Electric Company, Schenectady, NY (US)

(21) Appl. No.: 14/288,443

(22) Filed: May 28, 2014

(51) Int. Cl. C02F 1/00; B01D 29/13; C02F 1/28

(52) U.S. Cl. CPC C02F 1/001; C02F 1/281; B01D 29/13; C02F 2301/08

(57) ABSTRACT

A water filter assembly includes a first filter cartridge and a second filter cartridge mounted to a manifold. The first and second filter cartridges are plumbed into the manifold such that unfiltered water from an inlet of the manifold flows in parallel to the first and second filter cartridges. A third filter cartridge is also mounted to the manifold. The third filter cartridge is plumbed into the manifold such that filtered water from the first and second filter cartridges is directed into the third filter cartridge.

### FIELD OF THE INVENTION

The present subject matter relates generally to water filters and manifolds for water filters.

### BACKGROUND OF THE INVENTION

Water filters are generally provided with a filtering medium, such as a block of activated carbon, a pleated polymer or cellulose sheet or hollow fiber tubes. The water filter's filtering medium reduces contaminants in water prior to delivering such water to a user. Thus, the water filter may be installed upstream of a dispensing point in order to filter water provided at the dispensing point.

Various filter mediums may be used to filter water. Certain filter media are adapted for coarse filtration and mechanically block relatively large particles, such as sand, rust and cysts, from water passing therethrough while permitting relatively small contaminants to pass through the filter media. Other filter media are adapted for fine or microbiological filtration and reduce contaminants, such as microbial or chemical contaminants, in water passing therethrough.

Fine filtration media may clog with large particles if exposed to water with large particles, and such clogging may reduce a filtering capacity of the fine filtration media. Thus, certain water filter assemblies include a coarse, pre-filtration filter medium positioned upstream of a fine filter medium in order to block relatively large particles from water provided to the fine filter medium and prevent or hinder the large particles from clogging the fine filter medium. However, the coarse, pre-filtration filter medium may reduce a flow rate of water through the water filter assembly. Thus, the volume of filtered water provided by the water filter assembly over a period of time may be increased if a coarse, pre-filtration filter medium is positioned upstream of a fine filter medium in the water filter assembly, but the flow rate of the water assembly will be reduced.

Accordingly, a water filter assembly with features for pre-filtering water supplied to a fine filter media of the water filter assembly would be useful. In particular, a water filter assembly with features for pre-filtering water supplied to a fine filter media of the water filter assembly while limiting or avoiding a reduction in a flow rate of water through the water filter assembly would be useful.

### BRIEF DESCRIPTION OF THE INVENTION

The present subject matter provides a water filter assembly. The water filter assembly includes a first filter cartridge and a second filter cartridge mounted to a manifold. The first and second filter cartridges are plumbed into the manifold such that unfiltered water from an inlet of the manifold flows in parallel to the first and second filter cartridges. A third filter cartridge is also mounted to the manifold. The third filter cartridge is plumbed into the manifold such that filtered water from the first and second filter cartridges is directed into the third filter cartridge. Additional aspects and advantages of the invention will be set forth in part in the following description, or may be apparent from the description, or may be learned through practice of the invention.

In a first exemplary embodiment, a water filter assembly is provided. The water filter assembly includes a manifold that defines an inlet conduit, a transfer conduit and an outlet conduit. A first filter cartridge is mounted to the manifold. The inlet conduit extends to the first filter cartridge. The inlet conduit is configured for directing water into the first filter cartridge. A second filter cartridge is also mounted to the manifold. The inlet conduit extends to the second filter cartridge. The inlet conduit is configured for directing water into the second filter cartridge. A third filter cartridge is also mounted to the manifold. The transfer conduit extends from the first and second filter cartridges to the third filter cartridge. The transfer conduit is configured for directing water from the first and second filter cartridges to the third filter cartridge. The outlet conduit extends from the third filter cartridge. The outlet conduit is configured for directing water out of the third filter cartridge.

In a second exemplary embodiment, a water filter assembly is provided. The water filter assembly includes a manifold having an inlet configured for directing unfiltered water into the manifold and an outlet configured for directing filtered water out of the manifold. A first filter cartridge and a second filter cartridge are mounted to the manifold. The first and second filter cartridges are plumbed into the manifold such that unfiltered water from the inlet of the manifold flows in parallel to the first and second filter cartridges. A third filter cartridge is also mounted to the manifold. The third filter cartridge is plumbed into the manifold such that filtered water from the first and second filter cartridges is directed into the third filter cartridge. The third filter cartridge is also in fluid communication with the outlet of the manifold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water filter assembly according to an exemplary embodiment of the present subject matter.

FIG. 2 provides a front, elevation view of the exemplary water filter assembly of FIG. 1.

FIG. 3 provides a section view of the exemplary water filter assembly of FIG. 2 taken along the D-D section line of FIG. 2.

FIG. 4 provides a schematic view of certain components of the exemplary water filter assembly of FIG. 1.

FIG. 5 provides a section view of a first filter cartridge of the exemplary water filter assembly of FIG. 1.

FIG. 6 provides a section view of a third filter cartridge of the exemplary water filter assembly of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

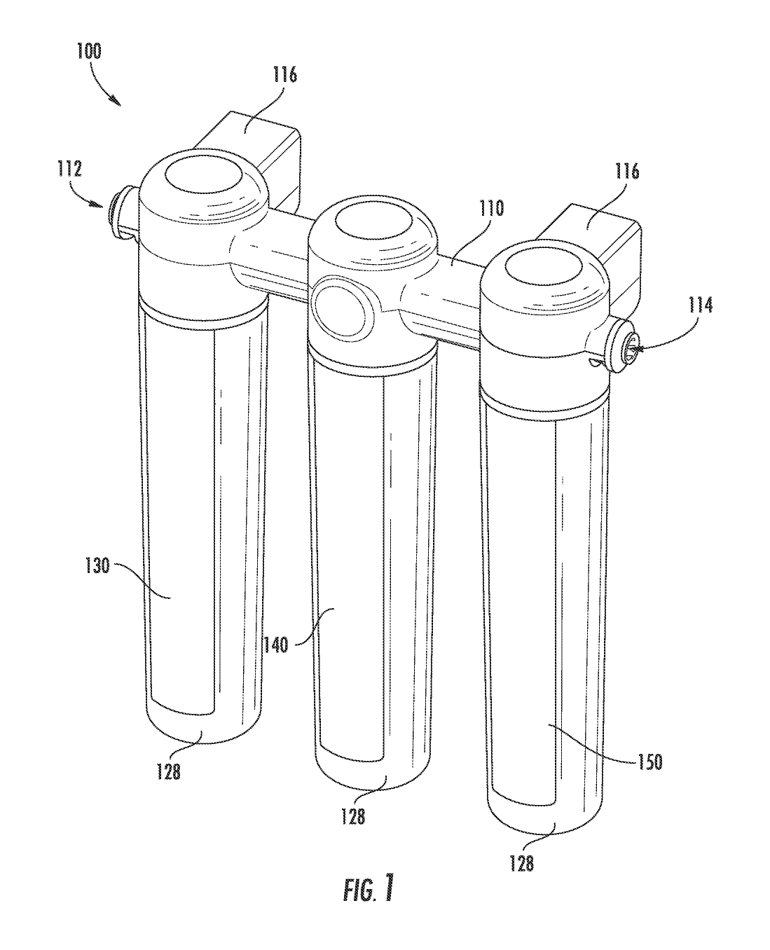

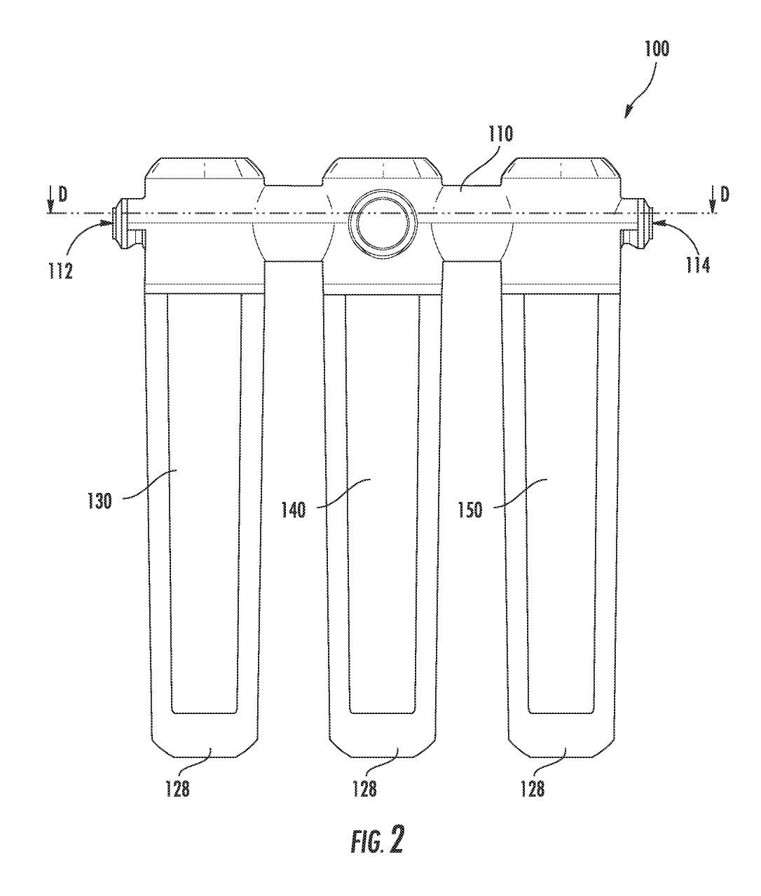

FIG. 1 provides a perspective view of a water filter assembly 100 according to an exemplary embodiment of the present subject matter. FIG. 2 provides a front, elevation view of water filter assembly 100. Water filter assembly 100 is configured for reducing contaminants such as chlorine, chloroform, lead, arsenic, pharmaceuticals, microbes, viruses, and/or other undesirable substances from water flowing therethrough. Water filter assembly 100 may be used in any suitable appliance, such as a refrigerator appliance or an ice maker appliance, as a point of use water filtration system, e.g., installed beneath a sink, or as a point of entry water filtration system for an entire household. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water filter assembly 100 includes a manifold 110 and at least three filter cartridges 128 mounted to manifold 110. Filter cartridges 128 may be removably mounted to manifold 110 in order to permit replacement of filter cartridges 128, e.g., when a filtering capacity of filter cartridges 128 is exhausted. As an example, filter cartridges 128 may be threaded onto manifold 110. In the exemplary embodiment shown in FIG. 1, filter cartridges 128 include a first filter cartridge 130, a second filter cartridge 140 and a third filter cartridge 150. It should be understood that in alternative exemplary embodiments, filter cartridges 128 may include any suitable number of filter cartridges. For example, filter cartridges 128 may include four, five, six, seven or more filter cartridges in alternative exemplary embodiments.

Manifold 110 includes mounting brackets 116. Fasteners (not shown) such as nails, pegs, tabs, screws, or bolts may be inserted through mounting brackets 116 to mount water filter assembly 100, e.g., to an appliance, to a kitchen cabinet beneath a kitchen sink, or to a wall within a house. Manifold 110 also defines an inlet or entrance 112 and an outlet or exit 114. Entrance 112 may be in fluid communication with a water supply and receive unfiltered water from the water supply. From entrance 112, such unfiltered water is directed into filter cartridges 128. Such unfiltered water passes through filter cartridges 128 and exits manifold 110 at exit 114 as filtered water, as discussed in greater detail below. Such filtered water may be directed to an ice maker within an appliance, a kitchen sink faucet, and/or any other suitable use.

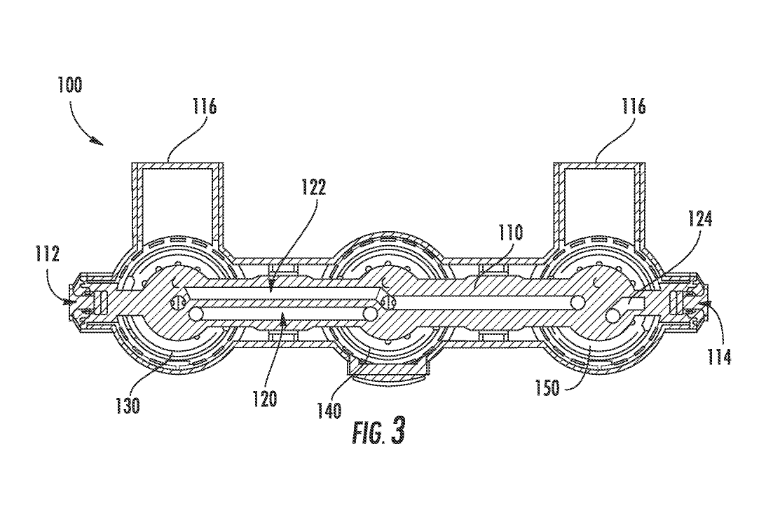

FIG. 3 provides a section view of water filter assembly 100. As may be seen in FIG. 3, manifold 110 includes or defines an inlet conduit 120, a transfer conduit 122 and an outlet conduit 124. As an example, manifold 110 may molded from a material, such as plastic, with inlet conduit 120, transfer conduit 122 and outlet conduit 124 formed therein. Inlet conduit 120 extends from entrance 112 of manifold 110 to first and second filter cartridges 130, 140. Thus, inlet conduit 120 is configured for directing unfiltered water from entrance 112 of manifold 110 into first and second filter cartridges 130, 140. Transfer conduit 122 extends from first and second filter cartridges 130, 140 to third filter cartridge 150. Thus, transfer conduit 122 is configured for directing water from first and second filter cartridges 130, 140 to third filter cartridge 150. Outlet conduit 124 extends from third filter cartridge 150 to exit 114 of manifold 110. Thus, outlet conduit 124 is configured for directing filtered water out of third filter cartridge 150 to exit 114 of manifold 110.

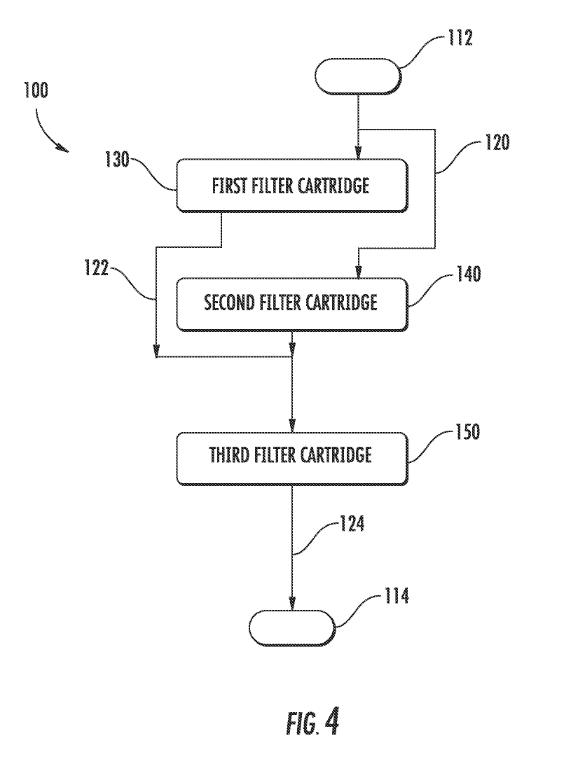

FIG. 4 provides a schematic view of certain components of water filter assembly 100. As may be seen in FIG. 4, inlet conduit 120 fluidly couples first and second filter cartridges 130, 140 and entrance 112 of manifold 110 such that unfiltered water from entrance 112 of manifold 110 flows in parallel to first and second filter cartridges 130, 140 via inlet conduit 120. Thus, first and second filter cartridges 130, 140 are plumbed into manifold 110 such that unfiltered water from entrance 112 of manifold 110 flows in parallel to first and second filter cartridges 130, 140. Due to the arrangement of inlet conduit 120, unfiltered water from entrance 112 of manifold 110 does not flow in series from first filter cartridge 130 to second filter cartridge 140.

First and second filter cartridges 130, 140 are positioned or disposed upstream of third filter cartridge 150. Transfer conduit 122 fluidly couples first and second filter cartridges 130, 140 to third filter cartridge 150 such that water from first and second filter cartridges 130, 140 is combined and supplied to third filter cartridge 150 via transfer conduit 122. Outlet conduit 124 fluidly couples third filter cartridge 150 to exit 114 of manifold 110 such that filtered water from third filter cartridge 150 is supplied to exit 114 of manifold 110 via outlet conduit 124. Thus, third filter cartridge 150 is plumbed into manifold 110 such that water from first and second filter cartridges 130, 140 is directed into third filter cartridge 150 and filtered water from third filter cartridge 150 is directed to outlet 114 of manifold 110. Through the use of a parallel flow path rather than a series flow path, the flow rate reduction in first and second filter cartridges 130, 140 is limited or reduced. In turn, an overall output flow rate of water filter assembly 100 may be improved or increased due to the parallel flow paths of first and second filter cartridges 130, 140.

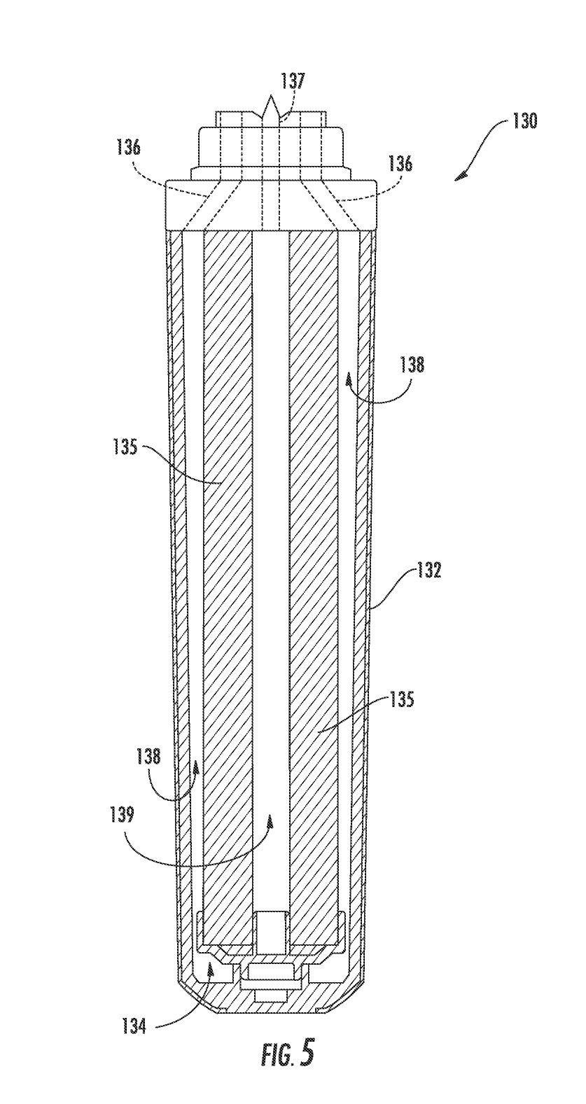

FIG. 5 provides a section view of first filter cartridge 130. Second filter cartridge 140 (FIG. 1) may constructed in the same or a similar manner as first filter cartridge 130. Thus, second filter cartridge 140 may include the same or similar components described below for first filter cartridge 130.

As may be seen in FIG. 5, first filter cartridge 130 includes a casing 132 that defines a chamber 134. First filter cartridge 130 defines an inlet passage 136 and an outlet passage 137, e.g., at a top portion of first filter cartridge 130. Inlet passage 136 is in fluid communication, e.g., extends between, inlet conduit 120 of manifold 110 (FIG. 3) and chamber 134 of casing 132. Thus, unfiltered water may flow from inlet conduit 120 of manifold 110 into chamber 134 of casing 132 via inlet passage 136 of first filter cartridge 130. Outlet passage 137 is in fluid communication, e.g., extends between, chamber 134 of casing 132 and transfer conduit 122 of manifold 110 (FIG. 3). Thus, filtered water may flow from chamber 134 of casing 132 into transfer conduit 122 of manifold 110 via outlet passage 137 of first filter cartridge 130.

A filtering medium 135 is disposed within chamber 134. Filtering medium 135 may be spaced apart from an inner surface of casing 132 as shown in FIG. 5. Filtering medium 135 divides chamber 134 of casing 132 into an unfiltered volume 138 and a filtered volume 139. Filtering medium 135 may reduce impurities and contaminants in water passing through filtering medium 135 from unfiltered volume 138 of first filter cartridge 130 to filtered volume 139 of first filter cartridge 130. Filtering medium 135 may include any suitable mechanism for filtering water such as, e.g., ceramic filter media, activated carbon filter media, polymer filter media, or reverse osmosis filter media. As will be understood by those skilled in the art, water filter assembly 100 may include additional filter media that filter water entering chamber 134. Thus, unfiltered volume 138 of first filter cartridge 130 may be filtered relative to other filter media but not filtering medium 135.

As an example, water passing through first filter cartridge 130 can follow a path through first filter cartridge 130. In particular, unfiltered water can enter first filter cartridge 130 through inlet passage 136 of first filter cartridge 130. Such unfiltered water may flow though inlet passage 136 of first filter cartridge 130 into unfiltered volume 138 of chamber 134. Such unfiltered water can pass though filtering medium 135 to reduce impurities and can exit filtering medium 135 into filtered volume 139 of first filter cartridge 130 as filtered water. Such filtered water may then pass or flow through outlet passage 137 of first filter cartridge 130 out of first filter cartridge 130.

In such a manner, unfiltered water can follow the path through first filter cartridge 130. In particular, unfiltered water can pass though filtering medium 135, and filtered water can exit first filter cartridge 130. Such filtering can improve taste and/or reduce harmful contaminants in water. In addition, such filtering may pre-filter water supplied to third filter cartridge 150 via transfer conduit 122 of manifold 110, as discussed in greater detail below.

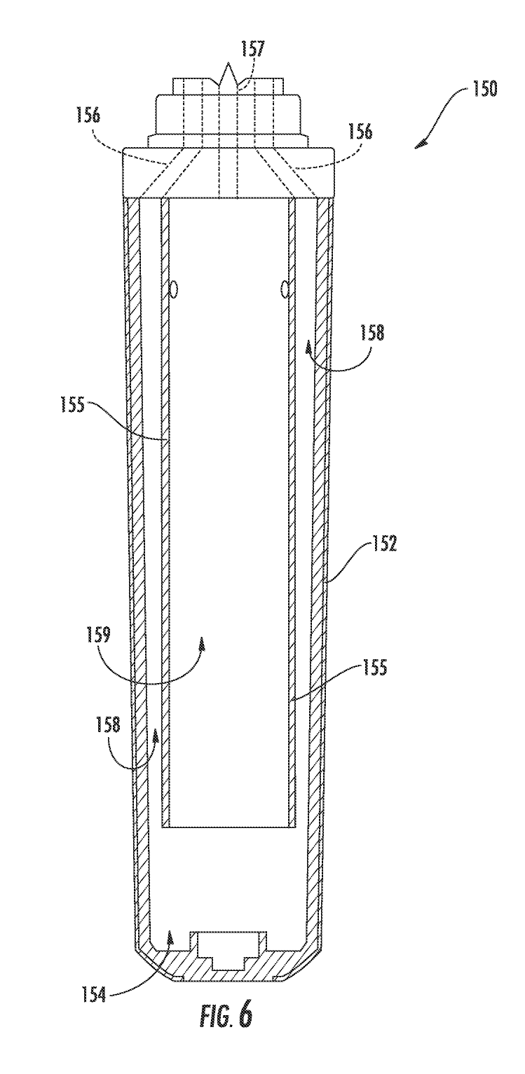

FIG. 6 provides a section view of third filter cartridge 150 of water filter assembly 100 (FIG. 1). As may be seen in FIG. 6, third filter cartridge 150 includes a casing 152 that defines a chamber 154. Third filter cartridge 150 defines an inlet passage 156 and an outlet passage 157, e.g., at a top portion of third filter cartridge 150. Inlet passage 156 is in fluid communication, e.g., extends between, transfer conduit 122 of manifold 110 (FIG. 3) and chamber 154 of casing 152. Thus, water may flow from transfer conduit 122 of manifold 110 into chamber 154 of casing 152 via inlet passage 156 of third filter cartridge 150. Outlet passage 157 is in fluid communication, e.g., extends between, chamber 154 of casing 152 and outlet conduit 124 of manifold 110 (FIG. 3). Thus, filtered water may flow from chamber 154 of casing 152 into outlet conduit 124 of manifold 110 via outlet passage 157 of third filter cartridge 150.

A filtering medium 155 is disposed within chamber 154. Filtering medium 155 may be spaced apart from an inner surface of casing 152 as shown in FIG. 6. Filtering medium 155 divides chamber 154 of casing 152 into an unfiltered volume 158 and a filtered volume 159. Filtering medium 155 may reduce impurities and contaminants in water passing through filtering medium 155 from unfiltered volume 158 of third filter cartridge 150 to filtered volume 159 of third filter cartridge 150. Filtering medium 155 may include any suitable mechanism for filtering water such as, e.g., ceramic filter media, activated carbon filter media, polymer filter media, or reverse osmosis filter media. As will be understood by those skilled in the art, water filter assembly 100 may include additional filter media that filter water entering chamber 154 of third filter cartridge 150. Thus, unfiltered volume 158 of third filter cartridge 150 may be filtered relative to other filter media but not filtering medium 155 of third filter cartridge 150.

As an example, water passing through third filter cartridge 150 can follow a path through third filter cartridge 150. In particular, water from first and second filter cartridges 130, 140 can enter third filter cartridge 150 through inlet passage 156 of third filter cartridge 150. Such water may flow though inlet passage 156 of third filter cartridge 150 into unfiltered volume 158 of chamber 154. Such water can pass though filtering medium 155 to remove impurities and can exit filtering medium 155 into filtered volume 159 of third filter cartridge 150 as filtered water. Such filtered water may then pass or flow through outlet passage 157 of third filter cartridge 150 out of third filter cartridge 150.

In such a manner, water from first and second filter cartridges 130, 140 can follow the path through third filter cartridge 150. In particular, water from first and second filter cartridges 130, 140 can pass though filtering medium 155, and filtered water can exit third filter cartridge 150. Such filtering can improve taste and/or safety of water. In addition, as discussed above, water from first and second filter cartridges 130, 140 is supplied to third filter cartridge 150 via transfer conduit 122. Thus, first and second filter cartridges 130, 140 may pre-filter water supplied to third filter cartridge 150. Pre-filtering may extend a life of third filter cartridge 150. For example, third filter cartridge 150 may configured or adapted to remove relatively small particles from water passing therethrough and first and second filter cartridges 130, 140 may be configured or adapted to remove relatively large particles from water passing therethrough. Thus, pre-filtering water supplied to third filter cartridge 150 may assist with preventing or limiting relatively large particles from clogging or blocking filtering medium 155 of third filter cartridge 150.

As an example, filtering medium 155 of third filter cartridge 150 may be configured for removing microbiological particles from water flowing therethrough while filtering medium 135 of first filter cartridge 130 may be configured for removing soil, rust, cysts, etc. from water flowing therethrough. In particular, first, second and third filter cartridges 130, 140, 150 may each include an activated carbon block. Pores of the activated carbon blocks of first and second filter cartridges 130, 140 may larger than pores of the activated carbon blocks of third filter cartridge 150. For example, the activated carbon block of third filter cartridge 150 may defines pores having a size less than about one micron in order to remove microbiological particles from water flowing through filtering medium 155 of third filter cartridge 150.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water filter assembly, comprising:
a manifold defining an inlet conduit, a transfer conduit and an outlet conduit;
a first filter cartridge mounted to the manifold, the inlet conduit extending to the first filter cartridge, the inlet conduit configured for directing water into the first filter cartridge;
a second filter cartridge mounted to the manifold, the inlet conduit extending to the second filter cartridge, the inlet conduit configured for directing water into the second filter cartridge; and
a third filter cartridge mounted to the manifold, the transfer conduit extending from the first and second filter cartridges to the third filter cartridge, the transfer conduit configured for directing water from the first and second filter cartridges to the third filter cartridge, the outlet conduit extending from the third filter cartridge, the outlet conduit configured for directing water out of the third filter cartridge.

2. The water filter assembly of claim 1, wherein the first, second and third filter cartridges each include an activated carbon block.

3. The water filter assembly of claim 2, wherein pores of the activated carbon blocks of the first and second filter cartridges are larger than pores of the activated carbon blocks of the third cartridge.

4. The water filter assembly of claim 1, wherein the third filter cartridge is configured for reducing microbiological particles from water flowing therethrough.

5. The water filter assembly of claim 4, wherein an activated carbon block of the third filter cartridge defines pores having a size less than about one micron.

6. The water filter assembly of claim 1, wherein the first and second filter cartridges each include an activated carbon block and the third filter cartridge includes hollow tube filtration media.

7. The water filter assembly of claim 1, wherein water supplied to the manifold flows in parallel to the first and second filter cartridges via the inlet conduit.

8. The water filter assembly of claim 1, wherein water supplied to the manifold does not flow in series from the first filter cartridge to the second filter cartridge.

9. The water filter assembly of claim 1, wherein the first, second and third filter cartridges are removably mounted to the manifold.

10. The water filter assembly of claim 9, wherein the first, second and third filter cartridges are threaded onto to the manifold.

11. A water filter assembly, comprising:
a manifold having an inlet configured for directing unfiltered water into the manifold and an outlet configured for directing filtered water out of the manifold;
a first filter cartridge and a second filter cartridge mounted to the manifold, the first and second filter cartridges plumbed into the manifold such that unfiltered water from the inlet of the manifold flows in parallel to the first and second filter cartridges; and
a third filter cartridge mounted to the manifold, the third filter cartridge plumbed into the manifold such that filtered water from the first and second filter cartridges is directed into the third filter cartridge, the third filter cartridge also in fluid communication with the outlet of the manifold.

12. The water filter assembly of claim 11, wherein the first, second and third filter cartridges each include an activated carbon block.

13. The water filter assembly of claim 12, wherein pores of the activated carbon blocks of the first and second filter cartridges are larger than pores of the activated carbon blocks of the third filter cartridge.

14. The water filter assembly of claim 11, wherein the third filter cartridge is configured for removing microbiological particles from water flowing therethrough.

15. The water filter assembly of claim 14, wherein an activated carbon block of the third filter cartridge defines pores having a size less than about one micron.

16. The water filter assembly of claim 11, wherein the first and second filter cartridges each include an activated carbon block and the third filter cartridge includes hollow tube filtration media.

17. The water filter assembly of claim 11, wherein the first, second and third filter cartridges are removably mounted to the manifold.

18. The water filter assembly of claim 17, wherein the first, second and third filter cartridges are threaded onto to the manifold.
